(19) United States
(12) Patent Application Publication
(10) Pub. No.: US 2024/0066805 A1
(43) Pub. Date: Feb. 29, 2024

(54) Three-Dimensional Modeling System

(71) Applicant: SEIKO EPSON CORPORATION, Tokyo (JP)

(72) Inventors: Taki HASHIMOTO, Shiojiri (JP); Masayuki GOZU, Ina (JP)

(21) Appl. No.: 18/455,753

(22) Filed: Aug. 25, 2023

(30) Foreign Application Priority Data
Aug. 26, 2022 (JP) 2022-135134

(51) Int. Cl. B29C 64/393; B29C 64/295; B29C 64/35

(52) U.S. Cl. CPC B29C 64/393; B29C 64/295; B29C 64/35; B33Y 30/00

(57) ABSTRACT

A three-dimensional modeling system includes: an ejection unit including a nozzle configured to eject a modeling material; a stage on which the modeling material is to be deposited; a movement unit configured to change relative positions of the ejection unit and the stage; a housing accommodating the ejection unit and the stage; a control unit configured to control the movement unit; and a reception unit configured to receive a mode related to maintenance of the ejection unit. The control unit controls the movement unit to move the ejection unit to a set position in the housing according to the mode received by the reception unit.

The present application is based on, and claims priority from JP Application Serial Number 2022-135134, filed on Aug. 26, 2022, the disclosure of which is hereby incorporated by reference herein in its entirety.

### BACKGROUND

### 1. Technical Field

The present disclosure relates to a three-dimensional modeling system.

### 2. Related Art

There is known a three-dimensional modeling system that models a three-dimensional modeled object by ejecting a plasticized material toward a stage and hardening the material.

For example, JP-A-2006-192710 discloses a modeling device including an extrusion nozzle that extrudes a thermoplastic material, which is melted when being heated by a preheater, onto a base, in which the extrusion nozzle is configured to perform scanning according to preset shape data, and a three-dimensional modeled object is formed by further depositing molten material onto the material hardened on the base.

However, in the modeling device disclosed in JP-A-2006-192710, when a user performs maintenance on the modeling device, an object to be maintained in the modeling device may be located at a position difficult for the user to access.

### SUMMARY

According to an aspect of the present disclosure, there is provided a three-dimensional modeling system including: an ejection unit including a nozzle configured to eject a modeling material; a stage on which the modeling material is to be deposited; a movement unit configured to change relative positions of the ejection unit and the stage; a housing accommodating the ejection unit and the stage; a control unit configured to control the movement unit; and a reception unit configured to receive a mode related to maintenance of the ejection unit, in which the control unit controls the movement unit to move the ejection unit to a set position in the housing according to the mode received by the reception unit.

### BRIEF DESCRIPTION OF THE DRAWINGS

FIG. 1 is a perspective view schematically showing a three-dimensional modeling system according to an embodiment.

FIG. 2 is a perspective view schematically showing the three-dimensional modeling system according to the embodiment.

FIG. 3 is a cross-sectional view schematically showing the three-dimensional modeling system according to the embodiment.

FIG. 4 is a perspective view schematically showing a flat screw of the three-dimensional modeling system according to the embodiment.

FIG. 5 is a plan view schematically showing a barrel of the three-dimensional modeling system according to the embodiment.

FIG. 6 is a cross-sectional view schematically showing the three-dimensional modeling system according to the embodiment.

FIG. 7 is a cross-sectional view schematically showing the three-dimensional modeling system according to the embodiment.

FIG. 8 is a cross-sectional view schematically showing the three-dimensional modeling system according to the embodiment.

FIG. 9 is a flowchart showing an operation of the three-dimensional modeling system according to the embodiment.

FIG. 10 is a cross-sectional view showing processing of forming modeling layers by the three-dimensional modeling system according to the embodiment.

FIG. 11 is a plan view schematically showing a three-dimensional modeling system according to a first modification of the embodiment.

FIG. 12 is a cross-sectional view schematically showing the three-dimensional modeling system according to the first modification of the embodiment.

FIG. 13 is a plan view schematically showing the three-dimensional modeling system according to the first modification of the embodiment.

FIG. 14 is a cross-sectional view schematically showing the three-dimensional modeling system according to the first modification of the embodiment.

FIG. 15 is a flowchart showing an operation of the three-dimensional modeling system according to the first modification of the embodiment.

### DESCRIPTION OF EMBODIMENTS

Hereinafter, a preferred embodiment of the present disclosure will be described in detail with reference to the drawings. The embodiment to be described below does not unduly limit the scope of the present disclosure described in the claims. In addition, not all configurations to be described below are necessarily essential components according to the present disclosure.

### 1. Three-Dimensional Modeling System

### 1.1. Overall Configuration

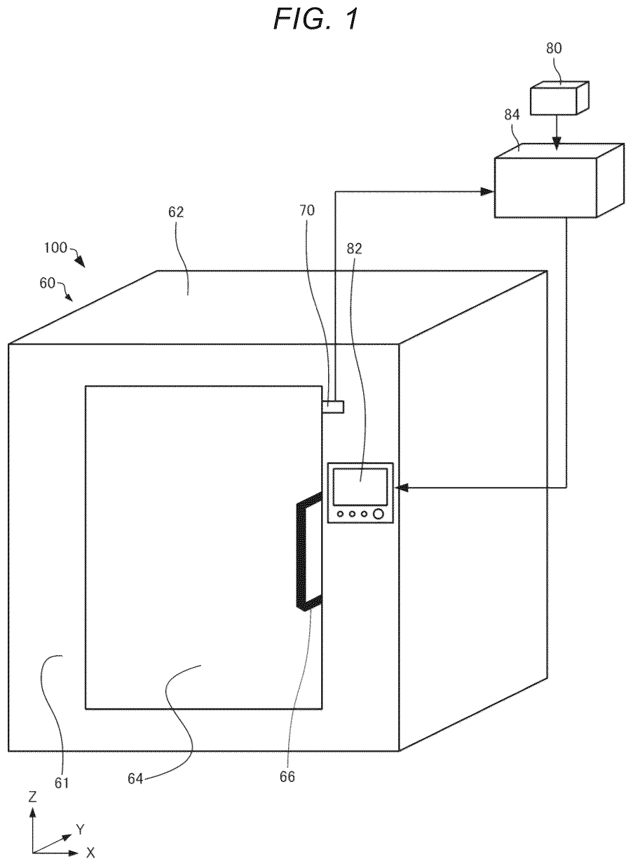

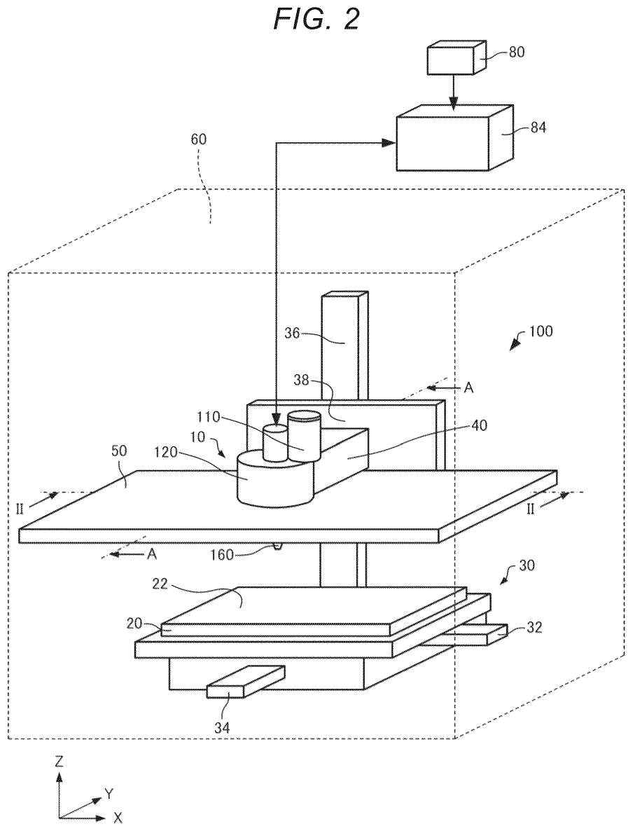

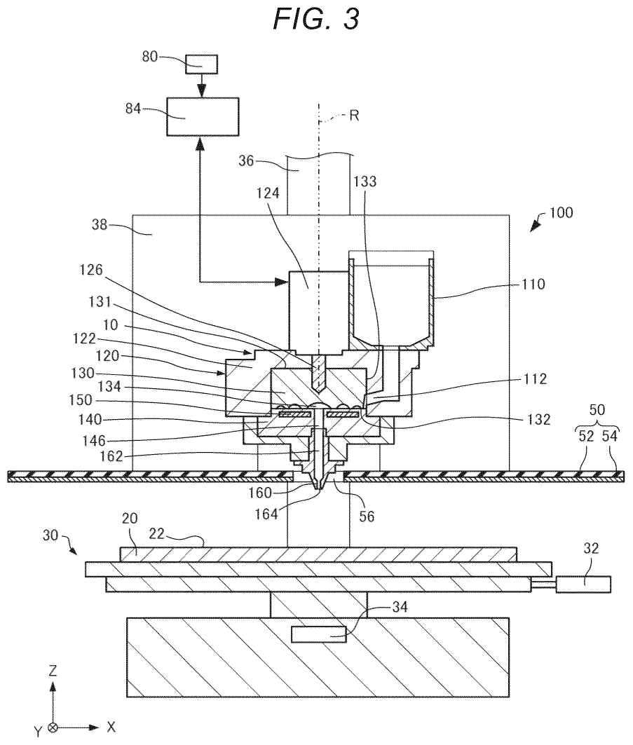

First, a three-dimensional modeling system according to the embodiment will be described with reference to the drawings. FIGS. 1 and 2 are perspective views schematically showing a three-dimensional modeling system 100 according to the embodiment. FIG. 3 is a cross-sectional view taken along a line II-II in FIG. 2 schematically showing the three-dimensional modeling system 100 according to the embodiment.

FIGS. 1 to 3 show an X axis, a Y axis, and a Z axis as three axes orthogonal to one another. An X-axis direction and a Y-axis direction are, for example, horizontal directions. A Z-axis direction is, for example, a vertical direction.

As shown in FIGS. 1 to 3, the three-dimensional modeling system 100 includes, for example, an ejection unit 10, a stage 20, a movement unit 30, a support member 40, a heating unit 50, a housing 60, an opening and closing sensor 70, a reception unit 80, a display unit 82, and a control unit 84.

For convenience, the opening and closing sensor 70 and the display unit 82 are not shown in FIG. 2, with the housing 60 being seen through. In FIG. 3, the housing 60, the opening and closing sensor 70, and the display unit 82 are not shown.

The three-dimensional modeling system 100 changes relative positions of the ejection unit 10 and the stage 20 by driving the movement unit 30 while ejecting a plasticized modeling material from the ejection unit 10 toward the stage 20. Accordingly, the three-dimensional modeling system 100 models a three-dimensional modeled object having a desired shape on the stage 20. The three-dimensional modeling system 100 is a three-dimensional modeling system of a fused deposition modeling (FDM) (registered trademark) type.

Although not shown, a plurality of ejection units 10 may be provided. For example, two ejection units 10 may be provided. In this case, both of the two ejection units 10 may eject a modeling material for forming the three-dimensional modeled object, or one may eject a modeling material and the other may eject a support material for supporting the three-dimensional modeled object. The two ejection units 10 may be arranged in the X-axis direction.

As shown in FIG. 3, the ejection unit 10 includes, for example, a material accommodating portion 110, a plasticizing part 120, and a nozzle 160.

The material accommodating portion 110 accommodates a pellet-shaped or powdery material. The material accommodating portion 110 supplies the material to the plasticizing part 120. The material accommodating portion 110 is implemented by, for example, a hopper. The material accommodated in the material accommodating portion 110 is, for example, acrylonitrile-butadiene-styrene (ABS) resin.

The material accommodating portion 110 and the plasticizing part 120 are coupled by a supply path 112 provided below the material accommodating portion 110. The material fed into the material accommodating portion 110 is supplied to the plasticizing part 120 via the supply path 112. In the shown example, “below” is a −Z-axis direction. “Above” is a +Z-axis direction.

The plasticizing part 120 includes, for example, a screw case 122, a drive motor 124, a flat screw 130, a barrel 140, and a heater 150. The plasticizing part 120 plasticizes at least a part of the material in a solid state supplied from the material accommodating portion 110, generates a paste-shaped modeling material having fluidity, and supplies the modeling material to the nozzle 160.

“Plasticizing” is a concept including melting, and means changing from a solid state to a flowable state. Specifically, for a material in which glass transition occurs, plasticizing means setting a temperature of the material to be equal to or higher than a glass transition point. For a material in which glass transition does not occur, plasticizing means setting a temperature of the material to be equal to or higher than a melting point.

The screw case 122 is a housing that accommodates the flat screw 130. The barrel 140 is provided on a lower surface of the screw case 122. The flat screw 130 is accommodated in a space surrounded by the screw case 122 and the barrel 140.

The drive motor 124 is provided on an upper surface of the screw case 122. The drive motor 124 is, for example, a servomotor. A shaft 126 of the drive motor 124 is coupled to an upper surface 131 of the flat screw 130.

The drive motor 124 is controlled by the control unit 84. Although not shown, the shaft 126 of the drive motor 124 and the upper surface 131 of the flat screw 130 may be coupled via a speed reducer.

The flat screw 130 has a substantially cylindrical shape in which a size in a direction of a rotation axis R is smaller than a size in a direction orthogonal to the direction of the rotation axis R. In the shown example, the rotation axis R is parallel to the Z axis. The flat screw 130 is rotated about the rotation axis R by a torque generated by the drive motor 124.

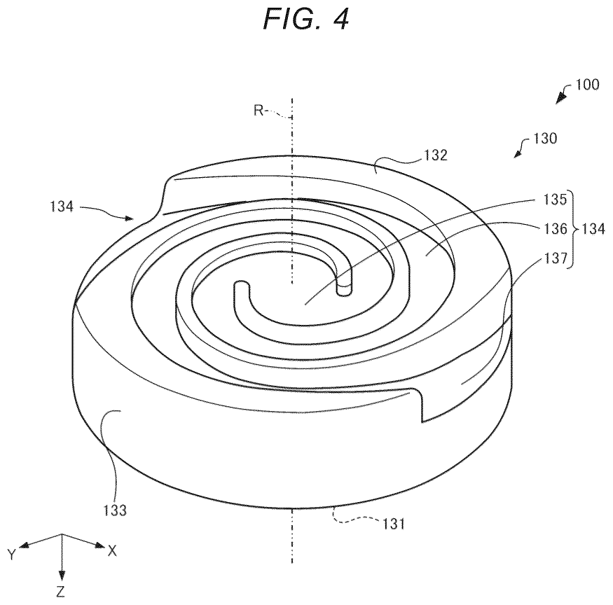

The flat screw 130 includes the upper surface 131, a groove forming surface 132 opposite from the upper surface 131, and a side surface 133 coupling the upper surface 131 and the groove forming surface 132. First grooves 134 are formed in the groove forming surface 132. The side surface 133 is, for example, perpendicular to the groove forming surface 132. Here, FIG. 4 is a perspective view schematically showing the flat screw 130. For convenience, FIG. 4 shows a state in which an upper-lower positional relationship is opposite to that in a state shown in FIG. 3.

As shown in FIG. 4, the first grooves 134 are formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the shown example, the coupling portion 136 is formed in a spiral shape from the central portion 135 toward an outer periphery of the groove forming surface 132. The material introduction portion 137 is formed in the outer periphery of the groove forming surface 132. That is, the material introduction portion 137 is formed in the side surface 133 of the flat screw 130. The material supplied from the material accommodating portion 110 is introduced from the material introduction portion 137 into the first groove 134, passes through the coupling portion 136 and the central portion 135, and is conveyed to the communication hole 146 formed in the barrel 140. For example, two first grooves 134 are formed.

The number of first grooves 134 is not particularly limited. Although not shown, three or more first grooves 134 may be formed, or only one first groove 134 may be formed.

Although not shown, the plasticizing part 120 may include an elongated in-line screw having a helical groove in a side surface, instead of the flat screw 130. The plasticizing part 120 may plasticize the material by rotation of the in-line screw.

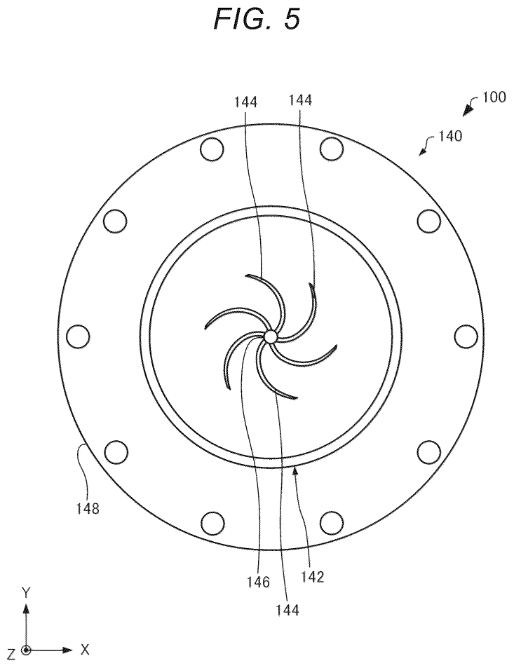

As shown in FIG. 3, the barrel 140 is provided below the flat screw 130. The barrel 140 includes a facing surface 142 facing the groove forming surface 132 of the flat screw 130. The communication hole 146 communicating with the first grooves 134 is formed at a center of the facing surface 142. Here, FIG. 5 is a plan view schematically showing the barrel 140.

As shown in FIG. 5, second grooves 144 and the communication hole 146 are formed in the facing surface 142 of the barrel 140. A plurality of second grooves 144 are formed. In the shown example, six second grooves 144 are formed, but the number of second grooves 144 is not particularly limited. The plurality of second grooves 144 are formed around the communication hole 146 as viewed in the Z-axis direction. One end of the second groove 144 is coupled to the communication hole 146, and the second groove 144 extends spirally from the communication hole 146 toward an outer periphery 148 of the barrel 140. The second groove 144 has a function of guiding the plasticized modeling material to the communication hole 146.

A shape of the second groove 144 is not particularly limited, and may be, for example, linear. One end of the second groove 144 may not be coupled to the communication hole 146. The facing surface 142 may not be provided with the second grooves 144. However, in consideration of efficiently guiding the plasticized material to the communication hole 146, the second groove 144 is preferably formed in the facing surface 142.

As shown in FIG. 3, the heater 150 is provided in the barrel 140. The heater 150 heats the material supplied between the flat screw 130 and the barrel 140. An output of the heater 150 is controlled by the control unit 84. The plasticizing part 120 generates, by the flat screw 130, the barrel 140, and the heater 150, the plasticized modeling material by heating the material while conveying the material toward the communication hole 146. Then, the plasticizing part 120 causes the generated modeling material to flow out from the communication hole 146.

The heater 150 may have a ring shape as viewed in the Z-axis direction. The heater 150 may be provided, for example, below the barrel 140 instead of in the barrel 140.

The nozzle 160 is provided below the barrel 140. A nozzle flow path 162 is formed in the nozzle 160. The nozzle flow path 162 communicates with the communication hole 146. The modeling material is supplied to the nozzle flow path 162 from the communication hole 146. The nozzle flow path 162 has a nozzle opening 164. The nozzle opening 164 is formed in a tip end portion of the nozzle 160. In the shown example, the nozzle opening 164 is formed in an end of the nozzle 160 in the −Z-axis direction. The nozzle 160 ejects the modeling material from the nozzle opening 164 toward the stage 20.

As shown in FIGS. 2 and 3, the stage 20 is provided below the nozzle 160. In the shown example, the stage 20 has a rectangular parallelepiped shape. The stage 20 includes a modeling surface 22 on which the modeling material is to be deposited. The modeling surface 22 is a region of an upper surface of the stage 20. The modeling material is deposited on the modeling surface 22.

A material of the stage 20 is, for example, a metal such as aluminum. The stage 20 may include a metal plate and an adhesive sheet provided on the metal plate. In this case, the modeling surface 22 is formed of the adhesive sheet. The adhesive sheet can improve adhesion between the stage 20 and the modeling material ejected from the ejection unit 10.

Although not shown, the stage 20 may include a metal plate in which a groove is formed, and a base layer that embeds the groove. In this case, the modeling surface 22 is formed of the base layer. A material of the base layer is, for example, the same as the modeling material. The base layer can improve the adhesion between the stage 20 and the modeling material ejected from the ejection unit 10.

The movement unit 30 supports the stage 20. The movement unit 30 changes the relative positions of the ejection unit 10 and the stage 20. In the shown example, the movement unit 30 changes relative positions of the nozzle 160 and the stage 20 in the X-axis direction and the Y-axis direction by moving the stage 20 in the X-axis direction and the Y-axis direction. Further, the movement unit 30 changes the relative positions of the nozzle 160 and the stage 20 in the Z-axis direction by moving the ejection unit 10 in the Z-axis direction.

The movement unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the ejection unit 10 and the heating unit 50 in the Z-axis direction.

A configuration of the movement unit 30 is not particularly limited as long as the movement unit 30 can change the relative positions of the ejection unit 10 and the stage 20. For example, the movement unit 30 may move the stage 20 in the Z-axis direction and move the ejection unit 10 in the X-axis direction and the Y-axis direction. Alternatively, the movement unit 30 may move the stage 20 or the ejection unit 10 in the X-axis direction, the Y-axis direction, and the Z-axis direction.

As shown in FIG. 2, the support member 40 is coupled to the movement unit 30. The support member 40 supports the ejection unit 10. In the shown example, the support member 40 extends in a −Y-axis direction from the movement unit 30 toward the ejection unit 10. The support member 40 may include an Oldham coupling.

The heating unit 50 is provided above the stage 20. The heating unit 50 moves in conjunction with movement of the ejection unit 10 relative to the stage 20. The heating unit 50 has a plate shape. In the shown example, the heating unit 50 has a rectangular parallelepiped shape. An area of the heating unit 50 is larger than an area of the stage 20 as viewed from the Z-axis direction.

The heating unit 50 heats the modeling material deposited on the stage 20 from above. This can improve adhesion between the modeling material deposited on the stage 20 and the subsequent modeling material deposited thereon.

As shown in FIG. 3, the heating unit 50 includes, for example, a heater 52 and a heat insulating member 54.

The heater 52 faces the modeling surface 22. The heater 52 is provided between the modeling surface 22 and the heat insulating member 54. The heater 52 is, for example, a plate-shaped heater plate. For example, a rubber heater is used as the heater 52. The heater 52 heats the modeling surface 22.

Although not shown, the heating unit 50 may include a metal plate below the heater 52. A material of the metal plate is, for example, aluminum.

The heat insulating member 54 is provided on the heater 52. The heat insulating member 54 is coupled to, for example, the support member 40. The heat insulating member 54 can reduce heat of the heater 52 transmitted upward from the heat insulating member 54.

A through hole 56 is formed in the heating unit 50. The through hole 56 penetrates the heater 52 and the heat insulating member 54 in the Z-axis direction. During modeling of a three-dimensional modeled object, the nozzle 160 is located in the through hole 56. Accordingly, a periphery of the nozzle 160 can be uniformly heated as viewed from the Z-axis direction. During modeling of the three-dimensional modeled object, the nozzle opening 164 is located between the heating unit 50 and the stage 20 in the Z-axis direction. The movement unit 30 moves the nozzle 160 upward and downward through the through hole 56. In the shown example, the nozzle 160 is moved in the Z-axis direction through the through hole 56 by driving of the movement unit 30.

As shown in FIGS. 1 and 2, the housing 60 accommodates the ejection unit 10, the stage 20, the movement unit 30, the support member 40, and the heating unit 50. The housing 60 has, for example, a substantially rectangular parallelepiped shape.

As shown in FIG. 1, the housing 60 includes, for example, a main body 62, a door 64, and a handle 66.

The main body 62 has a box shape. The main body 62 accommodates the ejection unit 10, the stage 20, the movement unit 30, the support member 40, and the heating unit 50.

The door 64 is coupled to the main body 62 via, for example, a hinge (not shown). The door 64 is provided in a side surface 61 of the housing 60. In the shown example, the side surface 61 is a surface facing the -Y-axis direction. The door 64 is rotatable about a hinge. For example, the hinge is provided at an end portion of the door 64 in a −X-axis direction. The door 64 may have an interlock.

The handle 66 is provided on the door 64. In the shown example, the handle 66 is provided at an end portion of the door 64 in a +X-axis direction. A user grips the handle 66 when opening and closing the door 64.

The opening and closing sensor 70 is provided on the housing 60. In the shown example, the opening and closing sensor 70 is provided on the side surface 61 of the housing 60. The opening and closing sensor 70 detects opening and closing of the door 64. A form of the opening and closing sensor 70 is not particularly limited as long as the opening and closing sensor 70 can detect opening and closing of the door 64.

The reception unit 80 is provided, for example, outside the housing 60. The reception unit 80 receives a user operation. The reception unit 80 transmits a signal to the control unit 84 according to the user operation. The reception unit 80 includes, for example, a mouse, a touch panel, and a keyboard.

The reception unit 80 receives a mode related to maintenance of the ejection unit 10. In other words, the reception unit 80 receives information on maintenance of the ejection unit 10. As a mode related to the maintenance of the ejection unit 10 received by the reception unit 80, there is a material supply mode for supplying a material to the material accommodating portion 110 of the ejection unit 10.

Further, as a mode related to the maintenance of the ejection unit 10 received by the reception unit 80, there is an ejection unit attachment and detachment mode for attaching and detaching the ejection unit 10. The ejection unit 10 is attachable and detachable. For example, the ejection unit 10 may be configured such that the nozzle 160 is attachable to and detachable from the barrel 140. Alternatively, the ejection unit 10 may be configured such that the nozzle 160 and the barrel 140 are attachable to and detachable from the flat screw 130. Alternatively, the ejection unit 10 may be configured such that the nozzle 160, the barrel 140, and the flat screw 130 are attachable to and detachable from the screw case 122. Alternatively, the ejection unit 10 may be attachable to and detachable from the support member 40.

The display unit 82 is provided on the housing 60. In the shown example, the display unit 82 is provided on the side surface 61 of the housing 60. The display unit 82 displays various images based on signals from the control unit 84. The display unit 82 includes, for example, a liquid crystal display (LCD), an organic electroluminescence (EL) display, or an electrophoretic display (EPD). The display unit 82 and the reception unit 80 may be integrally provided. In this case, the reception unit 80 may include a touch panel.

The control unit 84 is provided outside the housing 60. For example, the control unit 84 is implemented by a computer including a processor, a main storage device, and an input and output interface for receiving a signal from the outside and outputting a signal to the outside. For example, the control unit 84 exerts various functions by the processor executing programs read into the main storage device. Specifically, the control unit 84 controls the ejection unit 10, the movement unit 30, the heating unit 50, and the display unit 82. The control unit 84 may be implemented by a combination of a plurality of circuits instead of the computer. The control unit 84, the display unit 82, and the reception unit 80 may be integrally provided.

### 1.2. Position of Ejection Unit

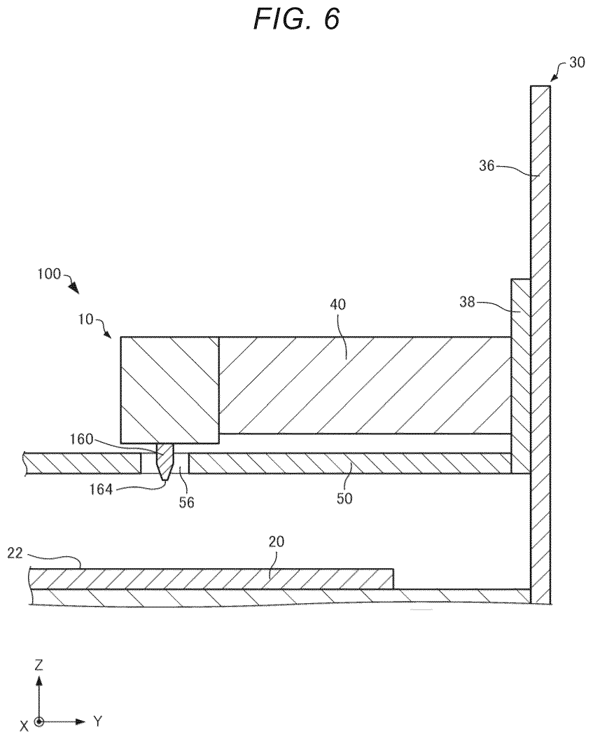

FIGS. 6 to 8 are cross-sectional views taken along a line A-A in FIG. 2 schematically showing the three-dimensional modeling system 100 according to the embodiment, and are cross-sectional views each showing a position of the ejection unit 10 in the Z-axis direction. Hereinafter, the “position in the Z-axis direction” is also referred to as a “height”. For convenience, the ejection unit 10 and the heating unit 50 are shown in a simplified manner in FIGS. 6 to 8.

As shown in FIGS. 6 to 8, the ejection unit 10 is coupled to the movement unit 30 by the support member 40. The movement unit 30 includes, for example, an elevating mechanism 38 that elevates and lowers the ejection unit 10 in the Z-axis direction. The third electric actuator 36 of the movement unit 30 supports the elevating mechanism 38. The support member 40 and the heating unit 50 are coupled to the elevating mechanism 38. The elevating mechanism 38 is located between the third electric actuator 36 and the support member 40. The elevating mechanism 38 is also located between the third electric actuator 36 and the heating unit 50.

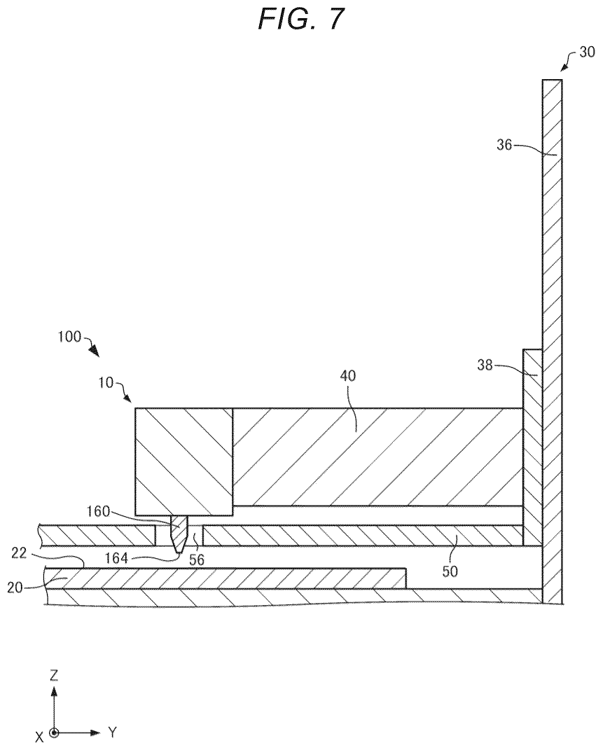

As shown in FIGS. 6 and 7, the third electric actuator 36 can move the elevating mechanism 38 in the Z-axis direction. Accordingly, the movement unit 30 can move the ejection unit 10 and the heating unit 50 in the Z-axis direction with respect to the stage 20 while maintaining a distance between the ejection unit 10 and the heating unit 50 constant.

A height of the ejection unit 10 and the heating unit 50 in a state shown in FIG. 6 is higher than a height of the ejection unit 10 and the heating unit 50 in a state shown in FIG. 7. The distance between the ejection unit 10 and the heating unit 50 in the Z-axis direction in the state shown in FIG. 6 is the same as the distance between the ejection unit 10 and the heating unit 50 in the Z-axis direction in the state shown in FIG. 7.

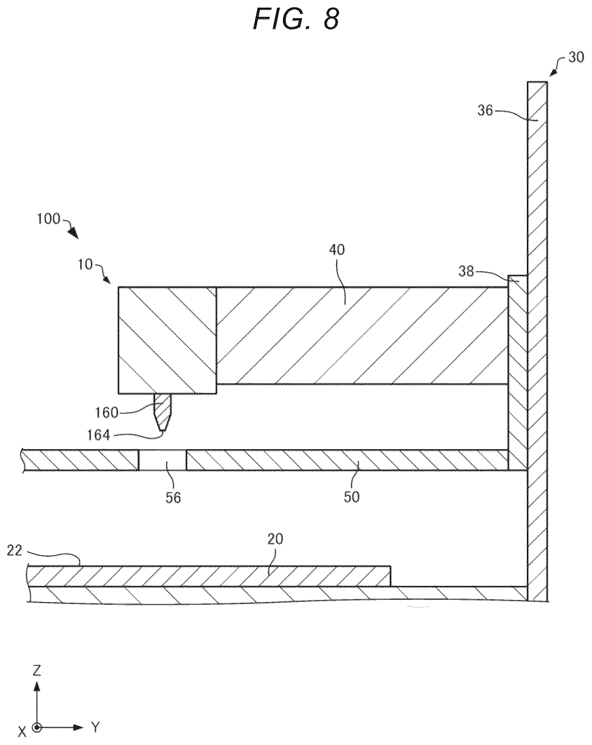

As shown in FIGS. 6 and 8, the elevating

mechanism 38 can move the support member 40 in the Z-axis direction with respect to the heating unit 50. That is, the elevating mechanism 38 can move the ejection unit 10 in the Z-axis direction with respect to the heating unit 50. Accordingly, the movement unit 30 can move the ejection unit 10 in the Z-axis direction with respect to the heating unit 50 while maintaining a distance between the stage 20 and the heating unit 50 constant. The elevating mechanism 38 may include a linear bush, an air cylinder, and the like.

The distance between the ejection unit 10 and the heating unit 50 in the state shown in FIG. 6 is smaller than the distance between the ejection unit 10 and the heating unit 50 in a state shown in FIG. 8. The distance between the stage 20 and the heating unit 50 in the Z-axis direction in the state shown in FIG. 6 is the same as the distance between the stage 20 and the heating unit 50 in the Z-axis direction in the state shown in FIG. 8.

The height of the ejection unit 10 changes due to a mode received by the reception unit 80. For example, when the reception unit 80 receives the material supply mode, the height of the ejection unit 10 changes to a lowest position in a movable range of the ejection unit 10 as shown in FIG. 7. When the reception unit 80 receives the ejection unit attachment and detachment mode, as shown in FIG. 8, the height of the ejection unit 10 changes to a position that is higher than that in the state shown in FIG. 7 and where the nozzle opening 164 of the ejection unit 10 is located above the through hole 56. FIG. 6 shows the height of the ejection unit 10 while the modeling material is being ejected from the nozzle 160.

The height of the ejection unit 10 when the reception unit 80 receives the material supply mode and the height of the ejection unit 10 when the reception unit 80 receives the ejection unit attachment and detachment mode may be settable for each user. The user may input user information before inputting the mode at the reception unit 80. Accordingly, the height of the ejection unit 10 when each mode is input may be set for each user.

The reception unit 80 may receive a manual mode in which the user can set the height of the ejection unit 10 as desired. After selecting the manual mode, the user can move the ejection unit 10 to a desired height by inputting a numerical value to the reception unit 80.

### 1.3. Operation

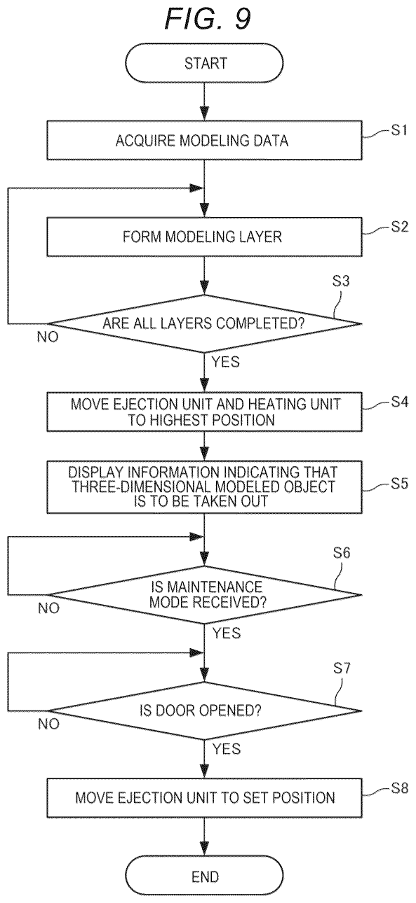

FIG. 9 is a flowchart showing an operation of the three-dimensional modeling system 100. Specifically, FIG. 9 is a flowchart showing processing of the control unit 84.

For example, the user operates the reception unit 80 to output, to the control unit 84, a processing start signal for starting processing. When receiving the processing start signal, the control unit 84 starts processing.

First, as shown in FIG. 9, in step S1, the control unit 84 executes processing of acquiring modeling data for modeling a three-dimensional modeled object.

The modeling data includes, for example, information on a type of a material accommodated in the material accommodating portion 110, a movement path of the ejection unit 10 relative to the stage 20, and an amount of the modeling material ejected from the ejection unit 10.

For example, the modeling data is created by reading shape data by slicer software installed in a computer provided in the three-dimensional modeling system 100. The shape data is data representing a target shape of the three-dimensional modeled object created using three-dimensional computer aided design (CAD) software, three-dimensional computer graphics (CG) software, or the like. For example, data in a standard triangulated language (STL) format or an additive manufacturing file format (AMF) is used as the shape data. The slicer software divides the target shape of the three-dimensional modeled object into layers each having a predetermined thickness, and creates modeling data for each layer. The modeling data is represented by a G code, an M code, or the like. The control unit 84 acquires the modeling data from a computer coupled to the three-dimensional modeling system 100 or a recording medium such as a universal serial bus (USB) memory.

Next, in step S2, the control unit 84 executes processing of forming modeling layers by ejecting the modeling material onto the modeling surface 22 of the stage 20.

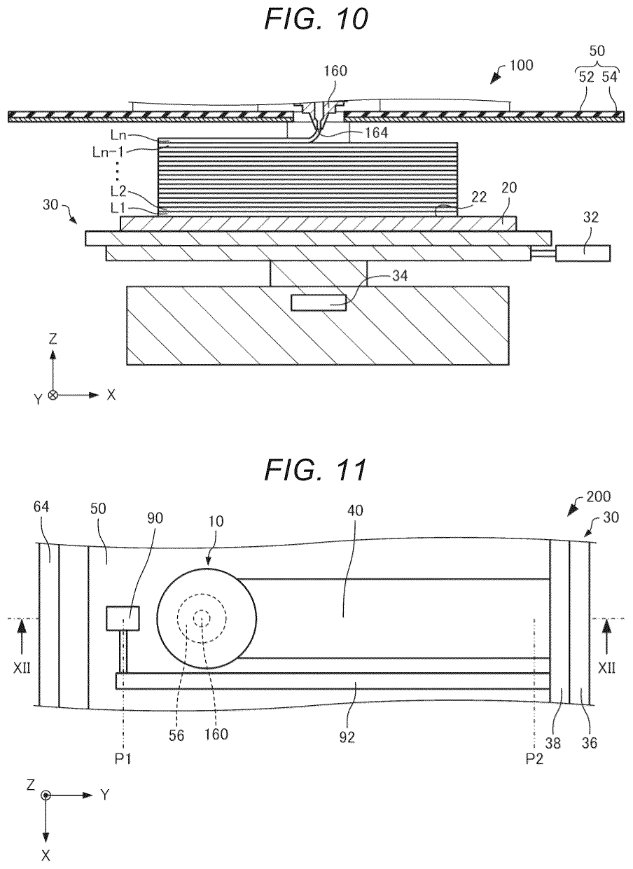

Specifically, the control unit 84 drives the drive motor 124 and the heater 150 to plasticize the material supplied between the flat screw 130 and the barrel 140 to generate the modeling material. Then, the control unit 84 ejects the modeling material from the nozzle opening 164 of the nozzle 160. For example, the control unit 84 continuously generates the modeling material until the processing of forming the modeling layers is ended. Here, FIG. 10 is a cross-sectional view showing the processing of forming the modeling layers.

As shown in FIG. 10, the control unit 84 controls the ejection unit 10 to eject the modeling material from the nozzle 160 toward the stage 20 while controlling the movement unit 30 to change the relative positions of the nozzle 160 and the stage 20 based on the acquired modeling data.

Specifically, before the processing of forming the modeling layers is started, that is, before formation of a modeling layer L1 that is a first modeling layer is started, the nozzle 160 is disposed at an initial position in the −X-axis direction with respect to an end portion of the stage 20 in the −X-axis direction. As shown in FIG. 10, when the processing of forming the modeling layers is started, the control unit 84 controls the movement unit 30 to move the nozzle 160 in the +X-axis direction with respect to the stage 20, for example. When the nozzle 160 passes over the stage 20, the modeling material is ejected from the nozzle 160. Accordingly, the modeling layer L1 is formed. In FIG. 10, n is any natural number, and layers up to an nth modeling layer Ln are shown.

Next, as shown in FIG. 9, in step S3, the control unit 84 executes processing of determining whether formation of all the modeling layers is completed based on the modeling data.

When determining that the formation of all the modeling layers is not completed (“NO” in step S3), the control unit 84 returns the processing to step S2. Then, the control unit 84 repeats step S2 and step S3 until determining in step S3 that the formation of all the modeling layers is completed.

On the other hand, when determining that the formation of all the modeling layers is completed (“YES” in step S3), the control unit 84 executes processing of controlling the movement unit 30 to move the ejection unit 10 and the heating unit 50 to a highest position in a movable range in step S4. Accordingly, when the user takes out the three-dimensional modeled object from the stage 20, a possibility that the ejection unit 10 and the heating unit 50 interfere with each other can be reduced.

Next, in step S5, the control unit 84 executes processing of displaying, on the display unit 82, information indicating that modeling of the three-dimensional modeled object is completed and information indicating that the user needs to take out the three-dimensional modeled object. Accordingly, desired information is displayed on the display unit 82.

Next, in step S6, the control unit 84 executes processing of determining whether the reception unit 80 receives a mode related to maintenance of the ejection unit 10 (hereinafter, also referred to as a “maintenance mode”) from the user.

When determining that the reception unit 80 does not receive a mode related to maintenance of the ejection unit 10 (“NO” in step S6), the control unit 84 repeats step S6 until determining in step S6 that the reception unit 80 receives the mode related to maintenance of the ejection unit 10.

On the other hand, when determining that the reception unit 80 receives the mode related to maintenance of the ejection unit 10 (“YES” in step S6), the control unit 84 executes, in step S7, processing of determining whether the door 64 of the housing 60 is opened after the end of the modeling.

Specifically, the control unit 84 determines whether the door 64 is opened after the end of the modeling based on a detection signal from the opening and closing sensor 70. “After the end of the modeling” means after it is determined that the formation of all the modeling layers is completed in step S3.

More specifically, the control unit 84 stores, in a storage unit (not shown), information on opening and closing of the door 64 based on the detection signal of the opening and closing sensor 70. Then, the control unit 84 reads the information on opening and closing of the door 64 from the storage unit, and determines whether the door 64 is opened after the end of the modeling. When the door 64 is opened, the control unit 84 preferably stops operations of the ejection unit 10 and the movement unit 30 in order to ensure safety of the user.

When determining that the door 64 is not opened after the end of the modeling (“NO” in step S7), the control unit 84 repeats step S7 until determining in step S7 that the door 64 is opened after the end of the modeling. In this case, the control unit 84 does not delete the information displayed on the display unit 82 in step S5, but keeps the information displayed. Alternatively, the control unit 84 again displays, on the display unit 82, information indicating that the door 64 is to be opened and the three-dimensional modeled object is to be taken away in a more conspicuous manner than that displayed on the display unit 82 in step S5. The control unit 84 may display the information in a hopping-up manner.

On the other hand, when determining that the door 64 is opened after the end of the modeling (“YES” in step S7), the control unit 84 executes processing of controlling the movement unit 30 to move the ejection unit 10 to a set position in the housing 60 according to the maintenance mode received by the reception unit 80 in step S8.

Specifically, when the reception unit 80 receives a material supply mode, the control unit 84 controls the movement unit 30 to move the ejection unit 10 to a position that is lower than a position of the ejection unit 10 at the end of the modeling and where the nozzle opening 164 is lower than the heating unit 50 as shown in FIG. 7.

When the reception unit 80 receives an ejection unit attachment and detachment mode, the control unit 84 controls the movement unit 30 to move the ejection unit 10 to a position that is lower than the position of the ejection unit 10 at the end of the modeling and where the nozzle opening 164 is higher than the heating unit 50 as shown in FIG. 8.

Then, the control unit 84 ends the processing.

Although an example in which the three-dimensional modeling system 100 is of the FDM type has been described above, the three-dimensional modeling system according to the present disclosure may be of an inkjet (IJ) type, a binder jetting (BJ) type, or a direct metal deposition (DMD) type.

Although not shown, the three-dimensional modeling system 100 may include a sensor that detects whether the completed three-dimensional modeled object is taken away from the stage 20. With the sensor, the control unit 84 can determine whether the completed three-dimensional modeled object is taken away from the stage 20.

### 1.4. Operational Effects

In the three-dimensional modeling system 100, the reception unit 80 receives a maintenance mode for the ejection unit 10. According to the maintenance mode received by the reception unit 80, the control unit 84 controls the movement unit 30 to move the ejection unit 10 to a set position in the housing 60. Therefore, in the three-dimensional modeling system 100, the user can easily access the ejection unit 10 when performing maintenance on the ejection unit 10. Therefore, the user can easily perform maintenance on the ejection unit 10. Accordingly, usability can be improved.

For example, when the ejection unit is located at a high position, the user needs to climb onto a platform to perform maintenance on the ejection unit. Therefore, maintenance work is complicated. In the three-dimensional modeling system 100, since the ejection unit 10 can be moved to the set position in the housing 60, the user can easily perform maintenance on the ejection unit 10 without using a platform, for example, while sitting.

In the three-dimensional modeling system 100, when the reception unit 80 receives a material supply mode for supplying a material to the material accommodating portion 110 in the maintenance mode, the control unit 84 controls the movement unit 30 to move the ejection unit 10 to a position lower than a position of the ejection unit 10 at the end of modeling. In the three-dimensional modeling system 100, at the end of the modeling, the ejection unit 10 is located at a high position in order to easily take out the completed three-dimensional modeled object from the stage 20. Therefore, the ejection unit 10 is moved to the position lower than the position of the ejection unit 10 at the end of the modeling, whereby the user can easily access the ejection unit 10. Accordingly, the user can easily supply the material to the material accommodating portion 110.

In the three-dimensional modeling system 100, the set position of the ejection unit 10 is settable for each user. Therefore, for example, both tall and short users can easily access the ejection unit 10.

In the three-dimensional modeling system 100, the control unit 84 determines whether the door 64 of the housing 60 is opened after the end of the modeling. For example, when determining that the door 64 is not opened after the end of the modeling, the control unit 84 displays, on the display unit 82, information indicating that the three-dimensional modeled object is to be taken away from the stage 20. Accordingly, in the three-dimensional modeling system 100, it is possible to prevent the ejection unit 10 from being maintained in a state in which the three-dimensional modeled object is not taken away from the stage 20. When the ejection unit is being maintained in a state in which the three-dimensional modeled object is not taken away, the ejection unit and the three-dimensional modeled object may come into contact with each other, and the ejection unit or the three-dimensional modeled object may be damaged.

In the three-dimensional modeling system 100, when the reception unit 80 receives an ejection unit attachment and detachment mode for attaching and detaching the ejection unit 10 in the maintenance mode, the control unit 84 controls the movement unit 30 to move the ejection unit 10 to a position lower than the position of the ejection unit 10 at the end of the modeling and where the nozzle opening 164 is higher than the heating unit 50. Therefore, in the three-dimensional modeling system 100, it is possible to prevent the nozzle 160 from coming into contact with the heating unit 50 when attaching and detaching the ejection unit 10. When the nozzle comes into contact with the heating unit, the nozzle or the heating unit may be damaged.

In the three-dimensional modeling system 100, when the reception unit 80 receives the material supply mode in the maintenance mode, the control unit 84 controls the movement unit 30 to move the ejection unit 10 to a position where the nozzle opening 164 is lower than the heating unit 50. Therefore, in the three-dimensional modeling system 100, when the user supplies the material to the material accommodating portion 110, the ejection unit 10 can be moved to a sufficiently low position. Accordingly, the user can easily supply the material to the material accommodating portion 110.

### 2. Modification of Three-Dimensional Modeling System

### 2.1. First Modification

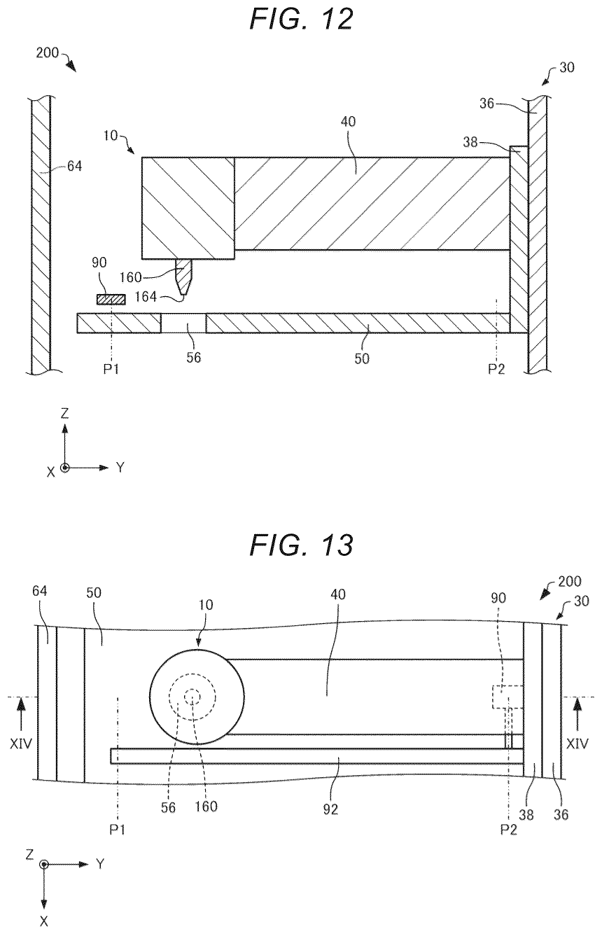

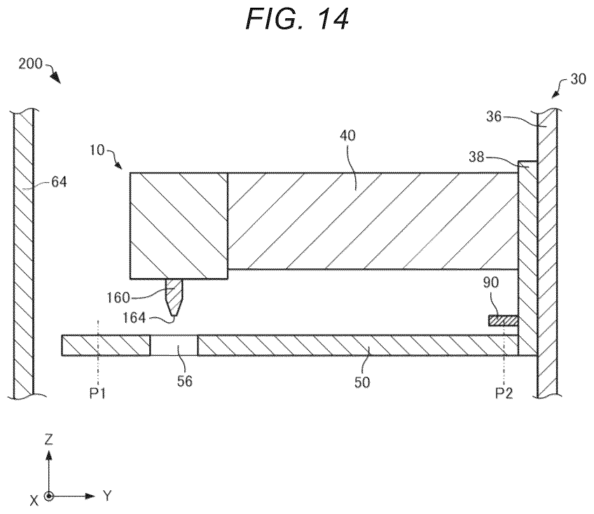

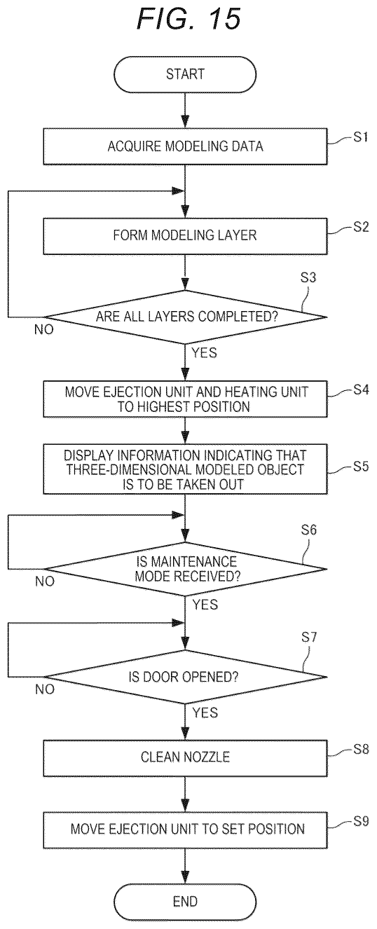

Next, a three-dimensional modeling system according to a first modification of the embodiment will be described with reference to the drawings. FIG. 11 is a plan view schematically showing a three-dimensional modeling system 200 according to the first modification of the embodiment. FIG. 12 is a cross-sectional view taken along a line XII-XII in FIG. 11 that schematically shows the three-dimensional modeling system 200 according to the first modification of the embodiment. FIG. 13 is a plan view schematically showing the three-dimensional modeling system 200 according to the first modification of the embodiment. FIG. 14 is a cross-sectional view taken along a line XIV-XIV in FIG. 13 that schematically shows the three-dimensional modeling system 200 according to the first modification of the embodiment. FIG. 15 is a flowchart showing an operation of the three-dimensional modeling system 200 according to the first modification of the embodiment.

Hereinafter, in the three-dimensional modeling system 200 according to the first modification of the embodiment, members having the same functions as constituent members of the three-dimensional modeling system 100 according to the embodiment described above are denoted by the same reference numerals, and detailed description thereof will be omitted.

As shown in FIGS. 11 to 14, the three-dimensional modeling system 200 is different from the three-dimensional modeling system 100 described above in that a cleaning mechanism 90 and a cleaning movement unit 92 are provided.

The cleaning mechanism 90 is provided above the heating unit 50. In the shown example, the cleaning mechanism 90 is located in the +Z-axis direction of the heating unit 50. The cleaning mechanism 90 cleans the nozzle 160. Specifically, the cleaning mechanism 90 clears modeling material clogging at the nozzle opening 164 of the nozzle 160. The cleaning mechanism 90 includes, for example, a brush that comes into contact with the nozzle 160, and an accommodating portion that accommodates the modeling material removed by the brush.

The cleaning movement unit 92 is provided above the heating unit 50. The cleaning movement unit 92 supports the cleaning mechanism 90. In the shown example, the cleaning movement unit 92 is coupled to the elevating mechanism 38. The cleaning movement unit 92 is controlled by the control unit 84.

The cleaning movement unit 92 moves the cleaning mechanism 90. In the shown example, the cleaning movement unit 92 moves the cleaning mechanism 90 along the Y axis. Specifically, the cleaning movement unit 92 moves the cleaning mechanism 90 in the Y-axis direction between a first position P1 and a second position P2.

FIGS. 11 and 12 show a state in which the cleaning mechanism 90 is located at the first position Pl. FIGS. 13 and 14 show a state in which the cleaning mechanism 90 is located at the second position P2.

The first position P1 is a position closer to the door 64 of the housing 60 than is the nozzle opening 164. The first position P1 is a position between the door 64 and the nozzle opening 164 as viewed in the Z-axis direction. The second position P2 is a position farther from the door 64 than is the nozzle opening 164. A distance between the second position P2 and the nozzle opening 164 is smaller than a distance between the second position P2 and the door 64. The cleaning movement unit 92 includes, for example, a rail and a motor.

As shown in FIG. 15, when the reception unit 80 receives a maintenance mode in step S6 and determines that the door 64 is opened in step S7, the control unit 84 executes processing of controlling the cleaning mechanism 90 to clean the nozzle 160 in step S8.

Specifically, the control unit 84 controls the movement unit 30 to move the ejection unit 10 to a position where the nozzle opening 164 is higher than the heating unit 50. Next, the control unit 84 controls the cleaning movement unit 92 to move the cleaning mechanism 90 to the second position P2. Next, the control unit 84 controls the cleaning movement unit 92 to move the cleaning mechanism 90 from the second position P2 to the first position Pl. Accordingly, the cleaning mechanism 90 comes into contact with the nozzle 160, and the nozzle 160 is cleaned.

In the processing of moving the ejection unit 10 to a set position in step S9, the control unit 84 maintains the cleaning mechanism 90 at the second position P2. The processing in step S9 shown in FIG. 15 is basically the same as the above-described processing in step S8 shown in FIG. 9.

In the three-dimensional modeling system 200, the cleaning movement unit 92 moves the cleaning mechanism 90 between the first position P1 closer to the door 64 than is the nozzle opening 164 and the second position P2 farther from the door 64 than is the nozzle opening 164. When the reception unit 80 receives the maintenance mode, the control unit 84 controls the cleaning movement unit 92 to move the cleaning mechanism 90 to the second position P2. Therefore, in the three-dimensional modeling system 200, when the user opens the door 64 to perform maintenance on the ejection unit 10, the cleaning mechanism 90 is less likely to interfere.

### 2.2. Second Modification

Next, a three-dimensional modeling system according to a second modification of the embodiment will be described. Hereinafter, in the three-dimensional modeling system according to the second modification of the embodiment, differences from the three-dimensional modeling system 100 according to the embodiment described above will be described, and description of the same points will be omitted.

In the three-dimensional modeling system 100 described above, the material accommodated in the material accommodating portion 110 is ABS resin.

However, in the three-dimensional modeling system according to the second modification of the embodiment, a material accommodated in the material accommodating portion 110 is a material other than the ABS resin, or a material obtained by adding other components to the ABS resin.

Examples of the material accommodated in the material accommodating portion 110 include materials having various materials such as a thermoplastic material, a metal material, and a ceramic material as main materials. Here, the “main material” means a material serving as a center forming a shape of a three-dimensional modeled object, and means a material occupying 50% by mass or more in the three-dimensional modeled object. The materials described above include those acquired by melting these main materials alone, and those acquired by melting a part of components contained together with the main materials into a paste form.

For example, a thermoplastic resin may be used as the thermoplastic material. Examples of the thermoplastic resin include a general-purpose engineering plastic and a super engineering plastic.

Examples of the general-purpose engineering plastic include polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyether sulfone (PES), polyphenylene sulfide (PPS), polyarylate (PAR), polyimide (PI), polyamideimide (PAI), polyetherimide (PEI), and polyether ether ketone (PEEK).

In addition to a pigment, a metal, and a ceramic, an additive such as a wax, a flame retardant, an antioxidant, and a heat stabilizer may be mixed into the thermoplastic material. In the plasticizing part 120, the thermoplastic material is plasticized and converted into a molten state by rotation of the flat screw 130 and heating of the heater 150. The modeling material generated in this manner is deposited from the nozzle 160 and then hardened by a decrease in temperature. The thermoplastic material is preferably heated to a temperature equal to or higher than a glass transition point thereof and ejected from the nozzle 160 in a completely molten state.

In the plasticizing part 120, for example, a metal material may be used as a main material instead of the thermoplastic material described above. In this case, it is desirable that a powder material obtained by powdering the metal material is mixed with a component that is melted during generation of the modeling material, and the mixture is fed into the plasticizing part 120.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, or maraging steel, and stainless steel, cobalt chromium molybdenum, a titanium alloy, a nickel alloy, an aluminum alloy, a cobalt alloy, and a cobalt chromium alloy.

In the plasticizing part 120, a ceramic material can be used as a main material instead of the metal material described above. Examples of the ceramic material include an oxide ceramic such as silicon dioxide, titanium dioxide, aluminum oxide, and zirconium oxide, and a non-oxide ceramic such as aluminum nitride.

A powder material of the metal material or the ceramic material accommodated in the material accommodating portion 110 may be a mixed material obtained by mixing a plurality of types of powder of a single metal or powder of an alloy, and powder of a ceramic material. The powder material made of the metal material or the ceramic material may be coated with, for example, the thermoplastic resin described above or another thermoplastic resin. In this case, in the plasticizing part 120, the thermoplastic resin may be melted to exhibit fluidity.

For example, a solvent may be added to the powder material made of the metal material or the ceramic material accommodated in the material accommodating portion 110. Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetate acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetyl acetone; alcohols such as ethanol, propanol, and butanol; tetraalkylammonium acetates; sulfoxide-based solvents such as dimethyl sulfoxide and diethyl sulfoxide;

pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material of the metal material or the ceramic material accommodated in the material accommodating portion 110. Examples of the binder include an acrylic resin, an epoxy resin, a silicone resin, a cellulose-based resin, and other synthetic resins, or PLA, PA, PPS, PEEK, and other thermoplastic resins.

The embodiment and modifications described above are merely examples, and the present disclosure is not limited thereto. For example, the embodiment and modifications may be combined as appropriate.

The present disclosure includes a configuration substantially the same as the configuration described in the embodiment, for example, a configuration having the same function, method, and result, or a configuration having the same purpose and effect. In addition, the present disclosure includes a configuration obtained by replacing a nonessential portion of the configuration described in the embodiment. In addition, the present disclosure includes a configuration having the same function and effect as the configuration described in the embodiment, or a configuration capable of achieving the same purpose. In addition, the present disclosure includes a configuration obtained by adding a known technique to the configuration described in the embodiment.

The following contents are derived from the embodiment and modifications described above.

A three-dimensional modeling system according to an aspect includes: an ejection unit including a nozzle configured to eject a modeling material; a stage on which the modeling material is to be deposited; a movement unit configured to change relative positions of the ejection unit and the stage; a housing accommodating the ejection unit and the stage; a control unit configured to control the movement unit; and a reception unit configured to receive a mode related to maintenance of the ejection unit, and the control unit controls the movement unit to move the ejection unit to a set position in the housing according to the mode received by the reception unit.

According to the three-dimensional modeling system, a user can easily access the ejection unit when performing maintenance on the ejection unit.

In the three-dimensional modeling system according to the aspect, the ejection unit may include a material accommodating portion configured to accommodate a material, and a plasticizing part configured to plasticize the material to generate the modeling material, and when the reception unit receives a material supply mode for supplying the material to the material accommodating portion in the mode, the control unit may control the movement unit to move the ejection unit to a position lower than a position of the ejection unit at an end of modeling.

According to the three-dimensional modeling system, the user can easily supply the material to the material accommodating portion.

In the three-dimensional modeling system according to the aspect, the set position may be settable for each user.

According to the three-dimensional modeling system, for example, both tall and short users can easily access the ejection unit.

In the three-dimensional modeling system according to the aspect, the housing may include a door, and the control unit may determine whether the door is opened after an end of modeling.

According to the three-dimensional modeling system, it is possible to prevent the ejection unit from being maintained in a state in which the three-dimensional modeled object is not taken away from the stage.

The three-dimensional modeling system according to the aspect may further include: a plate-shaped heating unit configured to heat the modeling material deposited on the stage from above and having a through hole, the movement unit may move the nozzle upward and downward through the through hole, and when the reception unit receives an ejection unit attachment and detachment mode for attaching and detaching the ejection unit in the mode, the control unit may control the movement unit to move the ejection unit to a position that is lower than a position of the ejection unit at an end of modeling and where a nozzle opening of the nozzle is higher than the heating unit.

According to the three-dimensional modeling system, it is possible to prevent the nozzle from coming into contact with the heating unit when attaching and detaching the ejection unit.

The three-dimensional modeling system according to the aspect may further include: a plate-shaped heating unit configured to heat the modeling material deposited on the stage from above and having a through hole, the movement unit may move the nozzle upward and downward through the through hole, and when the reception unit receives the material supply mode in the mode, the control unit may control the movement unit to move the ejection unit to a position where a nozzle opening of the nozzle is lower than the heating unit.

According to the three-dimensional modeling system, when the user supplies the material to the material accommodating portion, the ejection unit can be moved to a sufficiently low position.

The three-dimensional modeling system according to the aspect may further include: a plate-shaped heating unit configured to heat the modeling material deposited on the stage from above and having a through hole, the movement unit moving the nozzle upward and downward through the through hole; a cleaning mechanism provided above the heating unit and configured to clean the nozzle; and a cleaning movement unit configured to move the cleaning mechanism, the housing may include a door on a side surface, the cleaning movement unit may move the cleaning mechanism between a first position closer to the door than is a nozzle opening of the nozzle and a second position farther from the door than is the nozzle opening, and when the reception unit receives the mode, the control unit may control the cleaning movement unit to move the cleaning mechanism to the second position.

According to the three-dimensional modeling system, when the user opens the door to perform maintenance on the ejection unit, the cleaning mechanism is less likely to interfere.

What is claimed is:

1. A three-dimensional modeling system comprising:
an ejection unit including a nozzle configured to eject a modeling material;
a stage on which the modeling material is to be deposited;
a movement unit configured to change relative positions of the ejection unit and the stage;
a housing accommodating the ejection unit and the stage;
a control unit configured to control the movement unit; and
a reception unit configured to receive a mode related to maintenance of the ejection unit, wherein
the control unit controls the movement unit to move the ejection unit to a set position in the housing according to the mode received by the reception unit.

2. The three-dimensional modeling system according to claim 1, wherein
the ejection unit includes
a material accommodating portion configured to accommodate a material, and
a plasticizing part configured to plasticize the material to generate the modeling material, and
when the reception unit receives a material supply mode for supplying the material to the material accommodating portion in the mode, the control unit controls the movement unit to move the ejection unit to a position lower than a position of the ejection unit at an end of modeling.

3. The three-dimensional modeling system according to claim 1, wherein
the set position is settable for each user.

4. The three-dimensional modeling system according to claim 1, wherein
the housing includes a door, and
the control unit determines whether the door is opened after an end of modeling.

5. The three-dimensional modeling system according to claim 1, further comprising:
a plate-shaped heating unit configured to heat the modeling material deposited on the stage from above and having a through hole, wherein
the movement unit moves the nozzle upward and downward through the through hole, and
when the reception unit receives an ejection unit attachment and detachment mode for attaching and detaching the ejection unit in the mode, the control unit controls the movement unit to move the ejection unit to a position that is lower than a position of the ejection unit at an end of modeling and where a nozzle opening of the nozzle is higher than the heating unit.

6. The three-dimensional modeling system according to claim 2, further comprising:
a plate-shaped heating unit configured to heat the modeling material deposited on the stage from above and having a through hole, wherein
the movement unit moves the nozzle upward and downward through the through hole, and
when the reception unit receives the material supply mode in the mode, the control unit controls the movement unit to move the ejection unit to a position where a nozzle opening of the nozzle is lower than the heating unit.

7. The three-dimensional modeling system according to claim 1, further comprising:
a plate-shaped heating unit configured to heat the modeling material deposited on the stage from above and having a through hole, the movement unit moving the nozzle upward and downward through the through hole;
a cleaning mechanism provided above the heating unit and configured to clean the nozzle; and
a cleaning movement unit configured to move the cleaning mechanism, wherein
the housing includes a door on a side surface,
the cleaning movement unit moves the cleaning mechanism between a first position closer to the door than is a nozzle opening of the nozzle and a second position farther from the door than is the nozzle opening, and
when the reception unit receives the mode, the control unit controls the cleaning movement unit to move the cleaning mechanism to the second position.
